(19) United States
(12) Patent Application Publication
(10) Pub. No.: US 2005/0053694 A1
(43) Pub. Date: Mar. 10, 2005

(54) Method for making kimchi

(76) Inventors: Jae-Young Byun, Gyunggi-do (KR); Willis Soo Kang, Los Angeles, CA (US); Rena Kim, Los Angeles, CA (US)

Correspondence Address: RICHARD M. GOLDBERG, 25 EAST SALEM SREEET, SUITE 419, HACKENSACK, NJ, 07601, US

(21) Appl. No.: 10/940,521

(22) Filed: Sep. 14, 2004

(30) Foreign Application Priority Data
Mar. 14, 2003 (KR) 2003-15971

(51) Int. Cl. A23K 1/00

(52) U.S. Cl. 426/49

(57) ABSTRACT

A method for making kimchi includes the steps of before the liquefied dressing is poured into raw materials for kimchi and the raw materials are fermented, an adjusted amount of dried red pepper powder is added to a liquefied dressing so as to adjust a pungent taste of kimchi, and liquefied juice of various fruits is added to the liquefied dressing so as to make various kinds of kimchi being suitable to the tastes of younger generations and foreigners. Further, it is possible to develop kimchi to a healthy fermented food being effective to alleviate geriatric diseases such as diabetes and hypertension by adjusting the amount or kind of the additives.

### BACKGROUND OF THE INVENTION

1. Field of the Invention

The present invention relates to a method for making kimchi, and more particularly to a method for simply making kimchi by salting down raw materials such as Chinese cabbage, Chinese radish and/or other vegetables, adding liquefied dressing to the raw materials as needed, and ripening the obtained mixture.

2. Description of the Related Art

Generally, kimchi, which is a Korean traditional fermented food, is prepared by mixing salted main raw materials such as Chinese cabbage and Chinese radish, subsidiary raw materials such as green onion, garlic, ginger root, water cress, etc., and dressing containing dried red pepper powder and seasoning, adjusting the concentration of salt contained in the mixture, and adding fermented fish (referred to as a “jeotkal”) to the mixture, thus imparting a characteristic taste and flavor.

Kimchi is a leading one of fermented foods, and it is internationally known that fermented foods are good for health. Fermented foods are developed so as to be suitable to cultural and regional environments. For example, pickles and yogurts are typical fermented foods in foreign countries.

Since fermented foods contain a large quantity of minerals and vitamins and various lactic acid bacteria, which are good for health, they serve as health foods, which are necessary for our dietary habits and have tonic effects.

Hereinafter, the function of kimchi will be described in detail. Lactic acid bacteria in kimchi increase during a fermentation and ripening process, thereby sterilizing pathogenic microorganisms and converting sugar contained in vegetables to lactic acid, which has a light flavor.

The fermentation of kimchi is achieved by various kinds of the above-described lactic acid bacteria. That is, Leuconostoc mesenteroides acts on the fermentation of kimchi at an early stage so as to ripen the kimchi to a proper degree. Thereafter, Lactobacillus plantarum acts on the fermentation of kimchi at middle and late stages so as to kill harmful bacteria, but to make an excessively large quantity of acid, thus causing kimchi to be soured.

Furthermore, 30 kinds of bacteria inhabit kimchi, and the concentrations of each of these kinds of bacteria vary based on external temperature, humidity, and fermentation degree of the kimchi. The concentration of Lactic acid bacteria continuously increases up to 50 days from the preparation of kimchi at a temperature of 5° C., and then decreases rapidly. Accordingly, fermented kimchi is the most delicious and has plentiful nutritive elements at around 50 days from the preparation of kimchi.

Kimchi has several tens of various kinds by adding various kinds of jeotkal to kimchi during the fermentation process according to region. Kimchi contains a large quantity of nutrients necessary to the human body.

Conventionally, kimchi is made by steps of (i) preparing raw materials for kimchi, (ii) preparing dressing to be added to the raw materials, (iii) adding the dressing to the raw materials and (iv) fermenting the raw materials containing the dressing in a sealed container.

In step (i), in case that the raw materials for kimchi are Chinese cabbages, the Chinese cabbages are washed with clean water and are deposited in salted water for 10 hours to 15 hours so that salted water penetrates the Chinese cabbages to reduce the crispness of the cabbages, and the Chinese cabbages are taken out of the salted water and are naturally dehydrated.

In step (ii), Chinese radishes are cut into fine strips, salt is sprinkled onto the Chinese radish strips, and dried red pepper powder and smashed garlic and ginger root are mixed together with the Chinese radish strips. Further, various kinds of jeotkal and seasoning according to preference are mixed with the Chinese radish strips.

In steps (iii) and (iv), the mixed dressing is put into a gap between leaves of the salted Chinese cabbages, and the Chinese cabbages containing the mixed dressing are rolled by an end of the outer leave and are contained in a sealed container. Then, the Chinese cabbages in the container are fermented at room temperature for two days to fifteen days according to the season, thereby producing Chinese cabbage kimchi.

The above-described conventional method for making kimchi is disadvantageous in that is has a complicated and troublesome process. Particularly, when international ceremonies such as the Olympics in 1988 and the World Cup in 2002 were held, Korean traditional fermented food “kimchi” was popular with foreigners. However, it is difficult for foreigners to make kimchi due to a complicated process of the method for making kimchi and to store kimchi. Further, kimchi has a pungent taste and a bad smell, thus being disadvantageous in that it is often rejected by foreigners.

Moreover, kimchi is recently rejected often by younger generations due to its pungent taste and bad smell.

### SUMMARY OF THE INVENTION

Therefore, the present invention has been made in view of the above problems, and it is an object of the present invention to provide a method for making kimchi, in which dressing is liquefied, additives are added to the liquefied dressing, the liquefied dressing containing the additives is poured into raw materials for kimchi as needed, and then the obtained mixture is fermented for a designated period of time, thereby producing kimchi, which suits the tastes of younger generations or foreigners.

In accordance with the present invention, the above and other objects can be accomplished by the provision of a method for making kimchi comprising the steps of: (a) preparing raw materials for kimchi; (b) preparing dressing to be added to the raw materials; (c) mixing the dressing to the raw materials; and (d) fermenting the obtained mixture in a sealed container, wherein step (b) includes the sub-steps of: (b-1) preparing liquefied dressing by respectively liquefying Chinese radish, onion, garlic, carrot, red pepper and ginger root individually, and by mixing them; (b-2) adding fermented fish to the liquefied dressing, and mixing them; (b-3) adding additives to the liquefied dressing mixed with the fermented fish to be suitable to the tastes of foreigners or younger generations; and (b-4) pouring the liquefied dressing added with the additives to the raw materials, and fermenting the raw materials containing the liquefied dressing for a designated period of time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically illustrating a method for making kimchi in accordance with an embodiment of the present invention.

### DESCRIPTION OF THE PREFERRED EMBODIMENTS

Now, a method for making kimchi in accordance with a preferred embodiment of the present invention will be described in detail with reference to the annexed drawings.

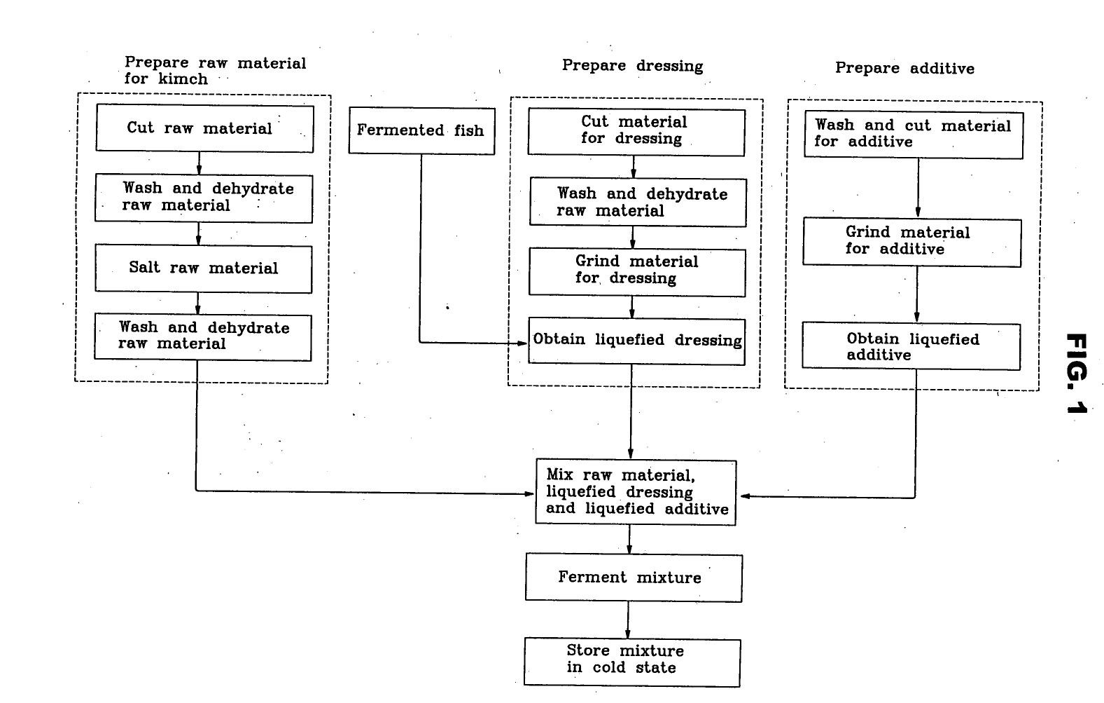

FIG. 1 is a block diagram schematically illustrating a method for making kimchi in accordance with the embodiment of the present invention. The method for making kimchi comprises the steps of: (a) preparing raw materials for kimchi; (b) preparing dressing to be added to the raw materials; (c) mixing the dressing to the raw materials; and (d) fermenting the obtained mixture in a sealed container, wherein step (b) includes the sub-steps of: (b-1) preparing liquefied dressing by respectively liquefying Chinese radish, onion, garlic, carrot, red pepper and ginger root individually, and by mixing them; (b-2) adding fermented fish to the liquefied dressing, and mixing them; (b-3) adding additives to the liquefied dressing mixed with the fermented fish to be suitable to the tastes of foreigners or younger generations; and (b-4) pouring the liquefied dressing added with the additives to the raw materials, and fermenting the raw materials containing the liquefied dressing for a designated period of time.

Hereinafter, the sub-steps (b-1) to (b-4) of step (b) of the method for making kimchi in accordance with the embodiment of the present invention will be described in detail.

First, Chinese radish, onion and carrot are washed with clean water, are cut into pieces having a length of 2 cm to 3 cm, and are then respectively juiced using a mixer. Further, garlic, ginger root and undried red pepper are washed with clean water and are then respectively juiced using the mixer.

The liquefied juices obtained by the above step are mixed in designated amounts. More particularly, the liquefied Chinese radish juice in an amount of 7 cc, the liquefied onion juice in an amount of 7 cc, the liquefied garlic juice in an amount of 0.25 cc, the liquefied carrot juice in an amount of 3 cc, the liquefied red pepper in an amount of 2 cc and the liquefied ginger root juice in an amount of 0.1 cc are mixed in a blender, thereby producing the liquefied dressing.

The above-described liquefied dressing is poured into the prepared raw materials in an amount of 100 g. Then, the raw materials are fermented, thereby producing kimchi. Kimchi has various kinds based on the prepared raw materials, such as Chinese cabbage kimchi using Chinese cabbage, kakdugi using Chinese radish, chonggak kimchi using young radish, mustard leaf kimchi using mustard leaf, cabbage kimchi using cabbage, kimchi using cucumber, water cress, green onion, etc.

For example, a method for manufacturing Chinese cabbage kimchi will be described, as follows. First, the outer leaves are eliminated from Chinese cabbages, and then the Chinese cabbages are divided into two or four equal pieces in a longitudinal direction according to the size of the Chinese cabbages. Divided Chinese cabbage pieces are soaked in salted water, washed with clean water, and then dehydrated.

The dehydrated Chinese cabbage pieces are preserved in salt by sprinkling salt onto the dehydrated Chinese cabbage pieces. When a designated time (generally, 10 hours to 15 hours) from the sprinkling of salt elapses, a salt component penetrates the Chinese cabbage pieces, thereby reducing crispness of the leaves of the Chinese cabbage pieces.

Then, the Chinese cabbages pieces are washed with clean water so that the salt component and/or foreign substances remaining on the surfaces of the leaves of the Chinese cabbages are eliminated, and are then dehydrated. Thereby, the preparation of the raw materials for kimchi is completed.

When the liquefied dressing is poured into the prepared raw materials, the liquefied dressing uniformly penetrates gaps between the leaves of the preserved Chinese cabbage pieces. The preserved Chinese cabbage pieces, onto which the liquefied dressing is poured, are fermented at a temperature in the range of 15° C. to 20° C. for 8 hours to 12 hours. Thereby, the making of kimchi is achieved.

Additives are added to the liquefied dressing prior to the fermentation. The additives include dried red pepper powder, and liquefied fruit juice containing orange, grape, apple, pear, peach, pineapple, kiwi, melon, etc., and serve to shorten the fermentation time by means of sugar contained therein and allow the made kimchi to suit the tastes of foreigners and younger generations.

That is, the additives are mixed with the liquefied dressing, and the mixture is poured into the preserved Chinese cabbage pieces so that the Chinese cabbage pieces are fermented. Here, since a pungent taste of the kimchi is controlled by adjusting the amount of the dried red pepper powder of the additives, it is possible to make kimchi, which suits the tastes of younger generations and foreigners. This type of kimchi is referred to as orange fermented kimchi, grape fermented kimchi, apple fermented kimchi, pear fermented kimchi, peach fermented kimchi, pineapple fermented kimchi, kiwi fermented kimchi or melon fermented kimchi, based on components of the additives.

A fermentation period of the kimchi made by the method of the present invention is five days in winter and one day in summer in a sealed container at a cool and well-ventilated space.

More specifically, the prepared kimchi is fermented at a temperature in the range of 15° C. to 20° C. for 8 hours to 12 hours under the condition that the temperature is adjusted, and is then stored in a cold state, thereby being maintained to have a fresh taste for a long period of time (40 days to 50 days).

As apparent from the above description, the present invention provides a method for making kimchi, in which before the liquefied dressing is poured into raw materials for kimchi and the raw materials are fermented, an adjusted amount of dried red pepper powder is added to the liquefied dressing so as to adjust a pungent taste of kimchi, and liquefied juice containing various fruits is added to the liquefied dressing so as to make various kinds of kimchi being suitable to the tastes of younger generations and foreigners. Particularly, it is possible to develop kimchi to a health fermented food being effective to alleviate geriatric diseases such as diabetes and hypertension by adjusting the amount or kind of the additives.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for making kimchi comprising the steps of:
(a) preparing raw materials for kimchi;
(b) preparing dressing to be added to the raw materials;
(c) mixing the dressing to the raw materials; and
(d) fermenting the obtained mixture in a sealed container,
wherein step (b) includes the sub-steps of:
(b-1) preparing liquefied dressing by respectively liquefying Chinese radish, onion, garlic, carrot, red pepper and ginger root individually, and by mixing them;
(b-2) adding fermented fish to the liquefied dressing, and mixing them;
(b-3) adding additives to the liquefied dressing mixed with the fermented fish to be suitable to the tastes of foreigners or younger generations; and
(b-4) pouring the liquefied dressing added with the additives to the raw materials, and fermenting the raw materials containing the liquefied dressing for a designated period of time.

2. The method as set forth in claim 1, wherein the liquefied dressing is obtained by mixing liquefied Chinese radish juice in an amount of 7 cc, liquefied onion juice in an amount of 7 cc, liquefied garlic juice in an amount of 0.25 cc, liquefied carrot juice in an amount of 3 cc, liquefied red pepper in an amount of 2 cc, and liquefied ginger root juice in an amount of 0.1 cc in a blender, per 100 g of the raw materials.

3. The method as set forth in claim 1, wherein the additives include dried red pepper powder, and liquefied fruit juice containing orange, grape, apple, pear, peach, pineapple, kiwi and melon.
